(19) United States
(12) Patent Application Publication
(10) Pub. No.: US 2014/0091781 A1
(43) Pub. Date: Apr. 3, 2014

(54) SECURITY SYSTEM

(71) Applicant: Hutchison International Ports Enterprises Limited, Road Town (VG)

(72) Inventors: Nicholas D. Cova, Salt Lake City, UT (US); Ryan Scott Luong Carpenter, Mid-Levels (CN)

(21) Appl. No.: 13/631,337

(22) Filed: Sep. 28, 2012

(51) Int. Cl. G01N 27/00

(52) U.S. Cl. 324/71.1

(57) ABSTRACT

Systems, apparatus, and methods disclosed herein feature a housing defining an interior cavity, a flexible cable including an electrically conductive body extending from a first end to a second end, at least a portion of the first and second ends of the cable configured to be held within the interior cavity, a locking assembly disposed in the interior cavity and configured to secure the cable to the housing, an electrical circuit disposed in the interior cavity, and a monitoring sub-system disposed within the interior cavity and configured to monitor an electrical state of the cable. The electrical circuit and the cable are arranged such that: a continuous electrical path is formed when the cable is secured to the housing by the locking assembly and at least a portion of each of the first and second ends of the cable are held within the interior cavity, and the electrical path is altered when the cable is detached from the housing, the cable is tampered with, or either of the first and second ends of the cable are entirely removed from the interior cavity.

### TECHNICAL FIELD

This specification generally relates to security systems for sealing various apparatus and devices against unauthorized access.

### BACKGROUND

Today's global markets rely heavily on shipping goods all over the world. Goods are shipped over sea, as well as over land and air, potentially passing through a variety of ports or stops along their way. The goods are transported intermodally, such as by ship, truck, and airplane. The shippers, carriers and receivers need to be sure that the product that is being shipped is safe from theft, tampering and contamination. Government agencies and insurance companies also are interested in ensuring that the cargo that is sent is received safely. To better be able to detect or track the occurrence of unauthorized or illegal activity, the goods can be secured and their movement through the supply chain tracked. However, various securing and tracking methods can be vulnerable to bypass or may fail to provide the information that is necessary to give a complete picture of the location, treatment and security of the goods while in transit.

For these and other reasons, new developments in the field of security systems for sealing apparatus such as entrance barriers of various shipping containers, trucks, and the like are continually sought.

### SUMMARY

This specification describes technologies related to security systems, apparatus, and methods for sealing various types of apparatus and devices against unauthorized access.

In one aspect, the systems, apparatus, and methods disclosed herein feature a housing defining an interior cavity, a flexible cable including an electrically conductive body extending from a first end to a second end, at least a portion of the first and second ends of the cable configured to be held within the interior cavity, a locking assembly disposed in the interior cavity and configured to secure the cable to the housing, an electrical circuit disposed in the interior cavity, and a monitoring sub-system disposed within the interior cavity and configured to monitor an electrical state of the cable. The electrical circuit and the cable are arranged such that: a continuous electrical path is formed when the cable is secured to the housing by the locking assembly and at least a portion of each of the first and second ends of the cable are held within the interior cavity, and the electrical path is altered when the cable is detached from the housing, the cable is tampered with, or either of the first and second ends of the cable are entirely removed from the interior cavity.

In some examples, the first end of the cable includes an elongated shank crowned by an enlarged head.

In some embodiments, the second end of the cable includes an open end of the cable.

In some implementations, the electrical circuit includes a first electrical contact positioned within the interior cavity so as to be in electrical communication with the first end of the cable, when the first end is held fixed within the interior cavity.

In some cases, the electrical circuit includes a second electrical contact positioned within the interior cavity so as to be in electrical communication with the second end of the cable, when the second end is held fixed within the interior cavity.

In some embodiments, the locking assembly includes: a primary lock including a one-way cable locking mechanism and a secondary lock including a button-release cable locking mechanism. In some applications, an electrical contact of the electrical circuit is integrated with the secondary lock of the locking assembly, such that the second end of the cable is held against the electrical contact by the secondary lock. In some examples, the secondary lock further includes a locking device including: a movable pin, and a driving mechanism responsive to the electrical state of the cable and configured to drive the pin between a first position where the pin impedes movement of a release button of the second secondary lock and a second position where the pin allows the release button to move freely. In some examples, the driving mechanism includes an electrical step motor. In some cases, the driving mechanism includes an electromagnetic motor.

In some embodiments, the monitoring sub-system includes a current sensor designed to detect changes in a current carried by the cable. In some examples, the current sensor includes a Rogowski coil for sensing current flux.

In some cases, the systems, apparatus, and methods also include an onboard computing device electronically connected to the monitoring sub-system, wherein the onboard computing device is configured to determine if the security system has been breached based on signals received from the monitoring sub-system. In some examples, the onboard computing device is configured to transmit system integrity information to an authorized receiver. In some implementations, the onboard computing device is configured to transmit location information to an authorized receiver. In some applications, the onboard computing device is configured to store system integrity information and/or location information in computer memory. In some cases, the systems, apparatus, and methods still further include an activation switch supported by the housing and electrically connected to the onboard computing device, a movable first access panel aligned with the activation switch, and a first panel lock disposed within the housing and arranged so as to impede movement of the first access panel when the first end of the cable is held fixed within the housing. In some embodiments, the first panel lock includes: a block positioned in a passageway of the housing and configured to contact the cable, when the cable is secured to the housing, a spring-biased post supporting the block, a sliding door-stop coupled to the post such that vertical movement of the post causes horizontal movement of the door-stop into a path of the first access panel. In some examples, the systems, apparatus, and methods still further include: a data link port supported by the housing and electrically connected to the onboard computing device, and a movable second access panel aligned with the data link port, and a second panel lock disposed within the housing and arranged so as to impede movement of the second access panel when the first end of the cable is held fixed within the housing. In some examples, the second panel lock includes: a block positioned in a passageway of the housing and configured to positioned in a passageway of the housing and configured to contact the cable, when the cable is secured to the housing, and a spring-biased door-stop coupled to the block such that vertical movement of the block causes horizontal movement of the door-stop into a path of the second access panel.

In some embodiments, the systems, apparatus, and methods further include a jam cleat mounted to the housing, the jam cleat including a base and a jaw, the base and the jaw together forming a clamp configured to receive and hold the cable. In some examples, a surface of the base includes a set of angled ridges.

In another aspect the systems, apparatus, and methods disclosed herein feature a housing defining an interior cavity, a flexible cable including a body extending from a first end to a second end, at least a portion of the first and second ends of the cable configured to be held within the interior cavity, a locking assembly disposed in the interior cavity and configured to secure the cable to the housing, and a monitoring sub-system disposed within the interior cavity and configured to generate a signal in the cable and to detect the signal to monitor a state of the cable. The monitoring sub-system and cable are configured such that: a continuous signal path is formed when the cable is secured to the housing by the locking assembly and at least a portion of each of the first and second ends of the cable are held within the interior cavity, and the signal path is altered when the cable is detached from the housing, the cable is tampered with, or either of the first and second ends of the cable are entirely removed from the interior cavity.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a front view of a security system for sealing various apparatus and devices against unauthorized access.

FIG. 1B is a rear view of the security system of FIG. 1A.

FIGS. 1C and 1D are side views of the security system of FIGS. 1A and 1B.

FIG. 1E is a cross-sectional view of the security system of FIGS. 1A-1D.

FIG. 2 is an enlarged perspective view of a security system featuring a jam cleat to hold a flexible security cable.

FIGS. 3A-3C are successive plan views illustrating a method of sealing an apparatus with a security system.

FIGS. 4A-4C are successive plan views illustrating a method of unsealing an apparatus with a security system.

One or more of the illustrated system components may be exaggerated to better show the features, process steps, and results achieved by embodiments of the present disclosure.

### DETAILED DESCRIPTION

One or more implementations of the present disclosure provide a security system that is highly resistant to being breached or tampered with, without the breach or tampering being detected (e.g., visibly or electronically). The security system may also be operable to track its position using an onboard global positioning system (GPS). In some examples, one or more authorized entities can remotely obtain access to information obtained by the security system electronics (e.g., the onboard computer), such as by receiving wireless transmissions from the system. However, the information may only be obtained by the authorized entities, or by unauthorized entities, using a wired communicator when a locking mechanism is released, or when the system is broken into. Such tampering is visibly and/or electronically discernible. Electromechanical assemblies described herein can be configured to detect each time the system is accessed, and thus only allow for authorized persons to obtain, modify or reset the data using a wired communicator without setting off any tampering alerts. In some examples, the security system can be incorporated into a network of various mechanical or electronic devices used as a whole to monitor shipping containers. For example, U.S. patent application Ser. No. 13/631,063, the entirety of which is incorporated herein by reference, describes how the security system can be used in conjunction with one or more “sensor pods” to monitor the environmental conditions within the shipping container.

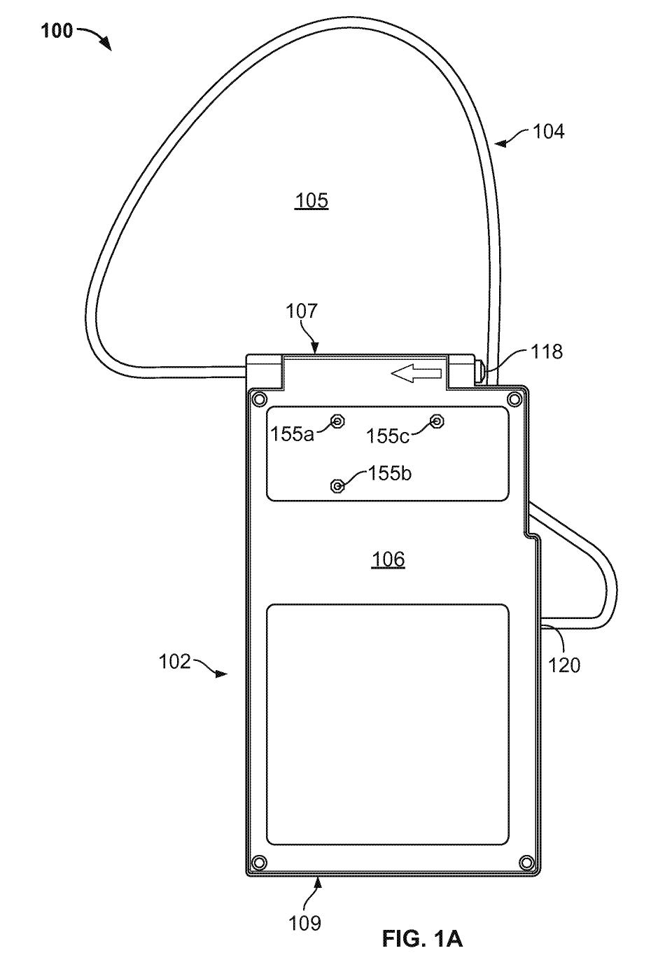

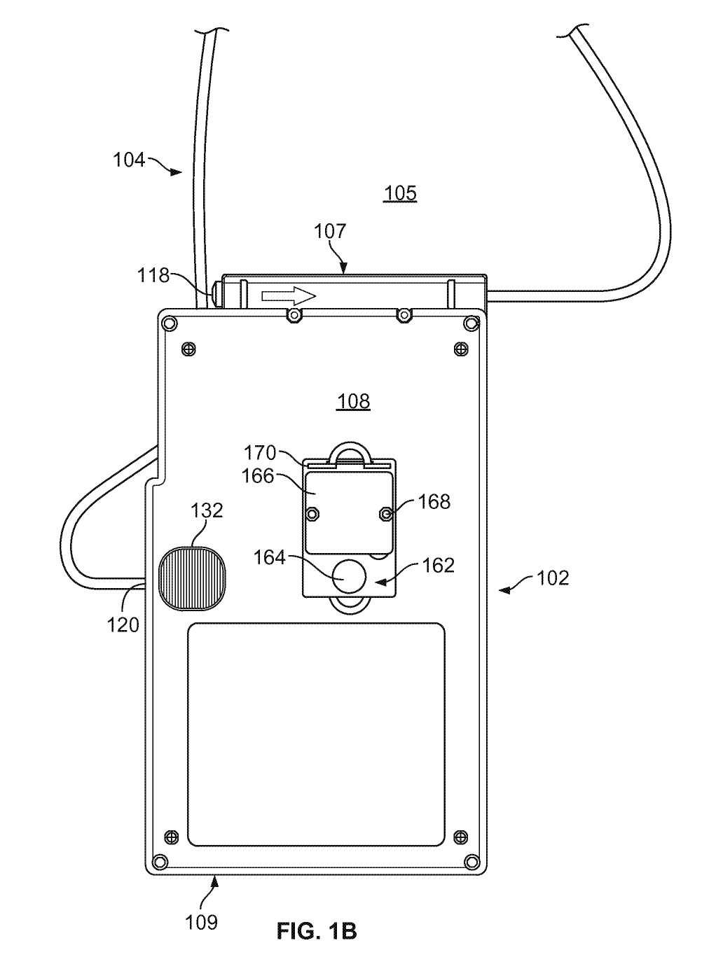

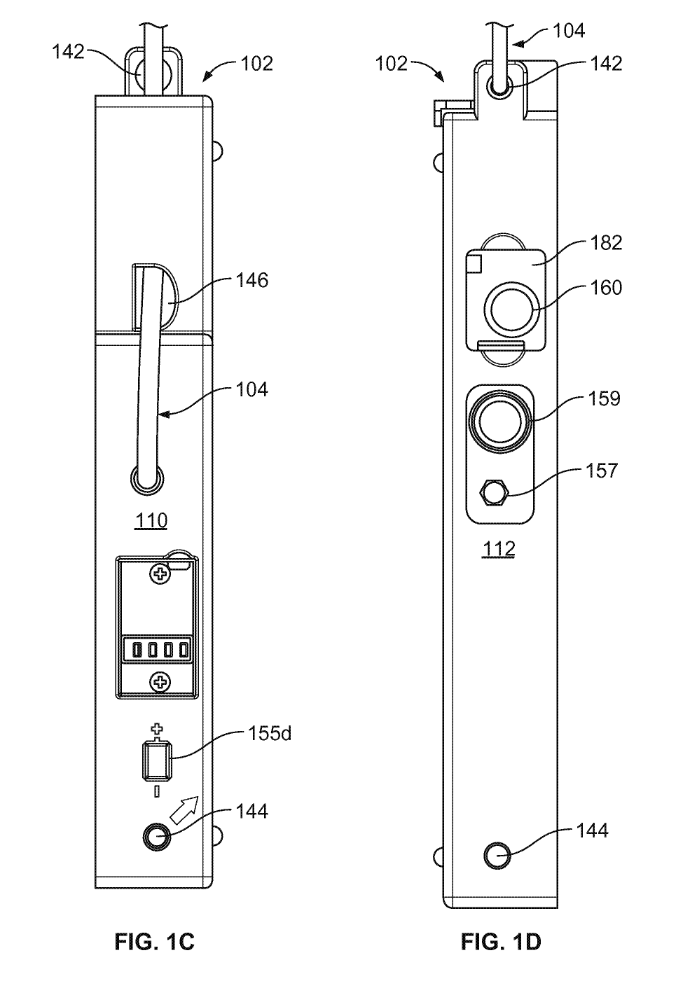

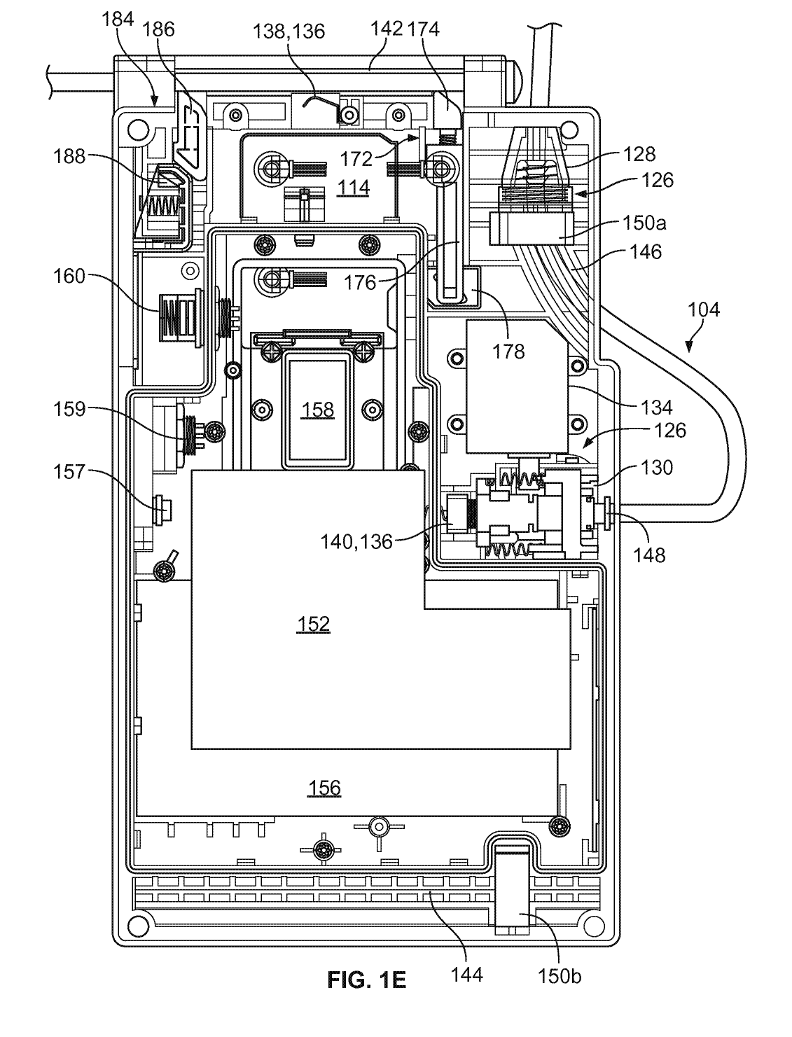

Referring to FIGS. 1A-1E, a security system 100 features a housing 102 and a flexible cable 104. As shown, the cable 104 can be securely attached to the housing 102. Together, the housing 102 and the attached cable 104 provide an adjustable loop 105 that can be used to mechanically tether (or “lock”) two separate objects together. For example, the loop 105 can be used to tether the lock rods of a shipping container, such that the doors of the shipping container cannot be opened without severing the cable 104 or otherwise detaching the cable from the housing 102. The security system 100 can be used in numerous applications for sealing various types of apparatus and devices. For example, the security system can be used to seal entrance barriers (e.g., doors or gates) by locking a latch or clasp, and/or by tethering door handles together. Numerous other types of apparatus and devices can be sealed by the security system. For instance, the security system can be used to seal valves, clamps, and other devices.

As shown, the housing has four outer faces 106-112 (namely, a front face 106, a back face 108, a right face 110, and a left face 112), as well as a top end 107 and a bottom end 109, that define and an interior cavity 114. The interior cavity 114 is appropriately designed to accommodate various electrical and mechanical components, as well as certain portions of the cable 104.

The cable 104 includes a flexible, electrically conductive body, extending from a first end 118 of the cable 104 to a second end 120 of the cable 104. The flexible body can, for example, be provided in the form of an insulated or sheathed electrical conductor (e.g., a single or multi-strand metallic wire). The flexible body can be designed to offer sufficient flexibility for wrapping the cable 104 around two objects to be tethered, as well as sufficient resistance to mechanical impact and environmental conditions to provide a strong, reliable lock. The first end 118 of the cable 104 is provided in the form of a rigid bolt-shaped structure 119 having an elongated shank crowned by an enlarged head, i.e., having a greater width than the cable 104. The bolt is fashioned from an electrically conductive material. The bolt is electrically connected to the flexible, electrically conductive body of the cable to serve as a first point of electrical contact for forming a continuous conductive path to carry a measurable current along the length of the cable. The second end 120 of the cable 104 is a cap-less, open end that provides a second point of electrical contact.

In a particular example, the flexible body of the cable 104 has four layers to provide a coaxial cable. The innermost core of the cable 104 is a single or multi-strand metallic wire electrically connected to the shank of the bolt 119. The core of the cable 104 is surrounded by a first insulating layer (e.g., a layer of plastic electrical insulating material). A reinforcement layer surrounds the first insulating layer. The reinforcement layer can, for example, be a relatively thick layer of braided steel designed to carry most of the tensile stress through the cable 104. The outermost layer is a second insulating layer, which can have a different or similar material composition than the first insulating layer, surrounding the reinforcement layer. Alternatively, the outer insulating layer could be omitted, and the outermost layer could be conductive.

As noted above, the interior cavity 114 is designed to accommodate certain portions of the cable 104. For example, as shown, the interior cavity 114 provides various passages adapted to receive the cable 104. In particular, the interior cavity includes an upper cable passage 142 and a lower cable passage 144 through which the cable 104 can freely pass. In use, a portion of cable 104 near the first end 118 extends through the upper cable passage 142. However, the head of the bolt-shaped structure at the first end 118 of the cable 104 is wider than the upper cable passage 142 so that the first end 118 of the cable cannot be pulled through the upper cable passage 142. Two additional cable passages 146 and 148 are used in conjunction with the cable locks described below.

The interior cavity 114 of the housing 102 is designed to accommodate a locking assembly 126 that secures the cable 104 to the housing to form the loop 105. The locking assembly 126 includes a primary cable lock 128 and a secondary cable lock 130. In this example, the primary cable lock 128 is a one-way locking mechanism providing a passageway through which the cable to allowed to advance, but not retract. Various types of one-way locking mechanisms can be used in conjunction with the embodiments described in this disclosure. As one example, the one-way locking mechanism may feature a spring loaded, cylindrical body having a central bore which provides the passage for receiving the cable. Multiple teeth extend from the inner surface of the body, towards the radial center of the bore. In this case, the teeth are biased so as to allow movement of the cable in one direction, while inhibiting movement in the opposite direction. As another example, the one-way locking mechanism can include a toothed locking component pivotally mounted in the passageway that receives the cable. As yet another example, a one-way clutch or cam system can be incorporated into the passageway to provide a suitable one-way locking mechanism.

The secondary cable lock 130 is configured to hold the second end 120 of the cable 104 in place. Various different types of mechanisms can be used to provide a secondary cable lock. In this example, the cable lock 130 is a spring loaded, button-release mechanism, which provides an opening that receives the second end 120 of the cable 104 and holds it in place under clamping pressure. A release button 132, which is accessible from the back face 108 of the housing 102, is designed to release the second end 120 of the cable 104 when pressed. A locking device 134 is used to prevent the cable 104 from being unintentionally released by the secondary cable lock 130. In some examples, the locking device 134 features a locking pin and a driving mechanism coupled to the locking pin. The driving mechanism is designed to move the pin between a first position, where the pin impedes movement of the release button 132, and a second position, where the pin allows the release button to move freely when pressed.

The driving mechanism of the locking device 134 can include an electrical (e.g., an electrical step-motor) or a magnetic (e.g., an electromagnet) motor. In some examples, the driving mechanism is designed to move the pin in response to a change in the electrical state of the cable 104 (by electrical state we refer to the electrical properties, transmission, and radiation state of the cable). For example, the drive system can be designed to move the pin into the first position, when the cable 104 is carrying current, and to move the pin from the first position to the second position, when the cable is not carrying a current. This technique would ensure that the cable 104 is not inadvertently released from the secondary cable lock 130 while the security system 100 is installed and activated. In fact, in some cases, the cable 104 must be severed, or the security system must be otherwise deactivated, to remove the cable from the secondary cable lock 130. In some examples, the drive system can be controlled by an onboard computing device and/or disabled so that the cable 104 can be released without beings severed, thus salvaging the cable for repeated use.

In addition to the locking assembly 126, an electrical circuit 136 is incorporated into the interior cavity 114 of the housing 102. As shown in FIG. 1E, the electrical circuit 136 includes a first electrical contact 138 and a second electrical contact 140 connected by an electrical wire (not shown). In this example, the first electrical contact 138 is a flexible shunt formed from an electrically conductive material. The first electrical contact 138 is positioned so as to contact a portion of cable 104 (e.g., the shank of the bolt 119 at the first end 118) that is positioned in the upper cable passage 142. The second electrical contact 140 is integrated with the secondary cable lock 130. In particular, the second electrical contact 140 is positioned so as to contact a portion of the cable 104 (i.e., the electrically conductive core of the cable 104) at the second end 120 when it is held security by the secondary cable lock 130. When the first and second electrical contacts 138 and 140 are coupled to the respective first and second ends 118 and 120 of the cable 104, a continuous conductive path is formed (when the cable 104 is a coaxial cable, dual conductive paths can be formed, and both conductive paths could be monitored). If a substantial voltage is applied to a component of the conductive path (e.g., to the first or second electrical contacts 138 and 140, or to the electrical wire connecting them), the cable 104 will carry a measurable current. As discussed in detail below, the current carried by the cable 104 can be monitored to determine if the security system 100 has been breached.

The security system 100 further includes a monitoring sub-system configured to detect changes in the state of the cable 104. For example, the monitoring subsystem can be designed to detect of the cable 104 has be severed or otherwise tampered with by detecting changes in: a) the electrical properties of the cable (e.g. impedance), b) changes in the electrical transmission of signals through the cable (e.g., by detecting reflected signals at the originating end, omitted signals at the terminating end, changes between a baseline of the original cable in e.g. phase or gain between the untampered and tampered cable states, changes between the delta between the untampered cable and a benchmark path and the tampered cable and the benchmark path, or distortions to the transmitted signal e.g. “noise”), and/or c) changes in the radiated properties of the cable (e.g. magnetic field, magnetic flux, Lorentz force, Laplace force, electromagnetic radiation). Accordingly, the monitoring sub-system features a pair of sensors 150a and 150b positioned within the interior cavity 114 that are designed to detect changes in the electrical current flowing through the cable 104. In particular, the first of the sensors 150a is positioned in the cable passage 146, which leads to the primary cable lock 128. The second of the sensors 150b is positioned in the lower cable passage 144.

In this example, the sensors 150a and 150b are Rogowski coils which measure current flux (i.e., the pulses of alternating current). For example, the Rogowski coils may be turned to measure alternating current in the range of 25 μA to 150 mA (e.g., about 25 mA). Various other types of current sensors can also be used in different embodiments, without departing from the spirit of the present disclosure. In any event, the sensors 150a and 150b can output a signal proportional to the measured current flux to an onboard computing device designed to determine if the security system has been breached or otherwise tampered with.

As noted above, the security system 100 includes an onboard computing device 152 (shown schematically herein). The onboard computing device 152 can include a main circuit board, and optionally one or more supplementary circuit boards, powered by an onboard battery pack 156 (e.g., a lithium-ion battery pack). The main circuit board may be disposed in a lower compartment of the interior cavity 114. In some examples, the main circuit board is a printed circuit board (PCB), which carries a number of computing and communication components. For example, the PCB can carry various chips, including computer memory, a transmitter, a processor, a GPS device, as well as various other types of components and sensors (e.g., a power management device and/or an accelerometer). The main circuit board can be used to control various electrical components incorporated into the security system 100.

The main circuit board can connect with various external devices. For example, the left face 112 of the housing includes a first connecting port 157 for an antenna (e.g., a short range communication antenna) plug-in to the main circuit board, as well as a second connecting port 159 for a sensor probe (such as can be used for obtaining temperature and/or humidity measurements). A secondary circuit board (not shown) may supports a removable subscriber identity module (SIM) card 158 that facilitates communication over wireless networks (e.g., GSM, 2G, 3G, or 4G networks). The SIM card 158 can be connected to a processor supported on the primary circuit board 154.

The onboard computing device 152 is configured to monitor the integrity of the security system 100. For instance, the onboard computing device 152 can receive signals from the electrical circuit 136 and/or the current sensors 150a and 150b to monitor system integrity. As one example, the onboard computing device 152 can monitor the state of the electrical circuit 136 (i.e., closed or open), and determine if/when a breach of the security system has occurred using a debounce method (such as described in US. Patent Publication 2011/0133932, the entirety of which is incorporated herein by reference). As another example, the onboard computing device 152 can monitor the electrical state of the cable 104 by receiving and deciphering signals from the current sensors 150a and 150b. Various other appropriate techniques for monitoring the electrical state of the electrical circuit 136 and/or the cable 104 may also be used (e.g., signal comparison or signal reflection techniques).

The onboard computing device 152 can be configured to monitor the physical state of the housing 102. For example, via an onboard accelerometer, the onboard computing device 152 can record significant impacts, drops, or crashes of the housing 102. The orientation of the housing 102 can also be monitored. In some examples, the onboard computing device 152 determines that the security system 100 has been breached based on monitoring the electrical state and the physical state of one or more system components.

The onboard computing device 152 may also be configured to send messages to an authorized receiver (not shown) regarding the monitored integrity of the security system 100. For instance, the onboard computing device 152 may be designed to send a tampering or breach alert to the authorized receiver. Additionally, or alternatively, the onboard computing device 152 can send data packets to the receiver at periodic intervals (e.g., every 5, 10 or 20 minutes). The onboard computing device 152 can also be designed to store system integrity information using computer memory.

In this example, the security system 100 includes multiple status indicator lights controlled by the onboard computing device 152. In particular, the security system 100 includes status indicator lights 155a, 155b, and 155c on the front face 106 of the housing 102 that provide a visual indication that the system is active and set (for example, each of the status indicator lights 155a-155c can display one of an electrical state of an electrical component or a physical state of a mechanical component in the security system 100); and a status indicator light 155d on the right face 110 of the housing 102 that provides a visual indication that the battery pack 156 is charged.

The onboard computing device 152 is integrated with a data link port 160 including a conventional plug interface that is directly connected to one or more components (e.g., a processor) supported on the main circuit board. The data link port 160 allows one or more external computing devices to access the onboard computing device 152. In some examples, the data link port 160 is configured to allow one-way transfer of data from the onboard computing device 152 to an external device, while inhibiting data transfer from the external device to the onboard device. This type of configuration can inhibit tampering with the onboard computing device 152 by preventing the upload of potentially harmful data packets by an external device.

As shown in FIG. 1B, the back face 108 of the housing 102 defines a first opening 162 aligned with the SIM card 158 and a push-button ON/OFF switch 164 that controls onboard computing device 152. The SIM card 158 is covered by an access plate 166 secured to the secondary circuit board by tamper-proof fasteners 168. A first access panel 170 is mounted on the housing 102. The first access panel 170 is movable (via a sliding motion), with respect to the housing 102, between a first (downward) position where the first opening 162 is covered by the panel, and a second (upward) position where the opening is at least partially uncovered by the panel, e.g., sufficiently uncovered to provide access to the SIM card 158 and the switch 164.

A first panel lock 172 is disposed in the interior cavity 114. The first panel lock 172 is designed such that the first access panel 170 cannot be opened while the cable 104 is appropriately situated in the upper cable passage 142. Thus, the first panel lock 172 is configured to inhibit the first access panel 170 from uncovering the first opening 162 when the security system 100 is active. As shown in FIG. 1E, the first panel lock 172 features a block 174 having an inclined face designed to contact the cable 104, with the block being situated on a spring-biased post 176. The post 176 is coupled to a sliding door-stop 178, such that vertical movement of the post causes horizontal movement of the door-stop. The first panel lock 172 is situated in the interior cavity 114 so that the block 174 is initially positioned in the upper cable passage 142. When the cable 104 is pushed through the upper cable passage 142, it contacts the inclined face of the block 174, forcing the post 176 vertically downward against the spring force. The downward movement of the post 176 causes the door-stop 178 to move horizontally outward into the sliding path of the first access panel 170, thereby inhibiting movement of the first access panel.

As shown in FIG. 1D, the left face 112 of the housing 102 defines a second opening (not shown) aligned with the data link port 160. A second access panel 182 is mounted on the housing 102. The second access panel 182 is movable (via a sliding motion), with respect to the housing 102, between a first (downward) position where the second opening is covered by the panel, and a second (upward) position where the opening is at least partially uncovered by the panel, e.g., sufficiently uncovered to provide access to the data port link 160.

A second panel lock 184 is disposed in the interior cavity 114. The second panel lock 184 is designed to inhibit the second access panel 182 from uncovering the second opening when the security system 100 is active. The second panel lock 184 features a block 186 abutting a spring biased door-stop 188. The block 186 defines an upper inclined face designed to contact the cable 104, and a lower inclined face contacting a matching surface of the door-stop 188. The block 186 and the door-stop 188 are arranged such that vertical movement of the block causes horizontal movement of the door-stop. The second panel lock 184 is situated in the interior cavity 114 so that the block 186 is initially positioned in the upper cable passage 142. When the cable 104 is pushed through the upper cable passage 142, it contacts the upper inclined face of the block 186, forcing the block downward against the door-stop. The door-stop 188 is pressed against the force of the spring to move horizontally outward into the sliding path of the second access panel 182, thereby inhibiting movement of the second access panel.

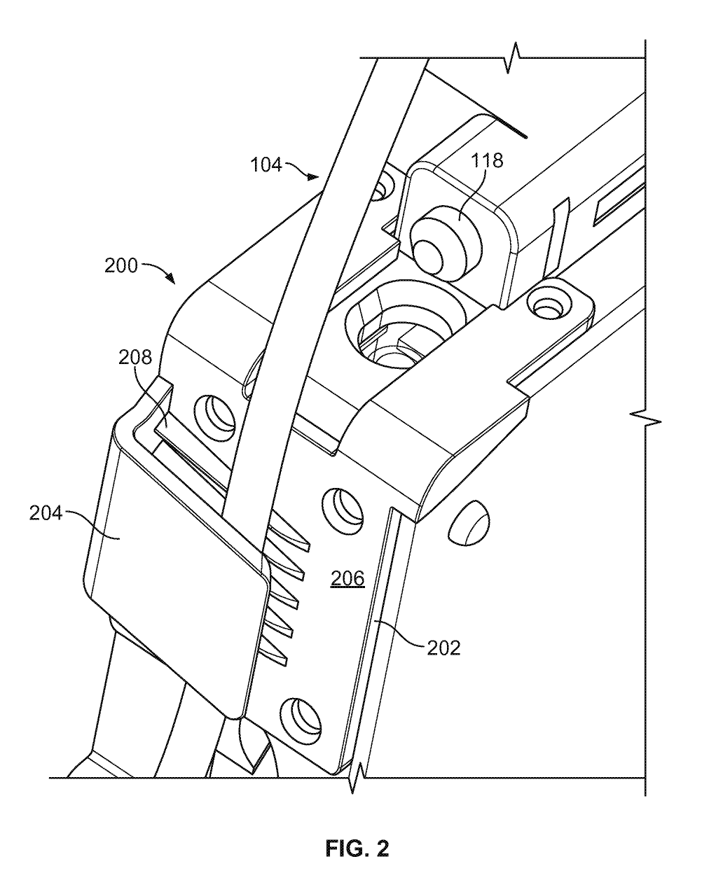

FIG. 2 shows an elective jam cleat 200 that can be secured to the upper right-hand corner of the housing 102. The jam cleat 200 can be used, for example, in lieu of the primary cable lock 128. The jam cleat 200 features a base 202 for mounting to the housing 102, and a jaw 204 extending from the base 202. The jaw 204, together with a surface 206 of the base 202, forms a clamp for holding the cable 104 in place. In particular, as shown, the surface 206 defines a set of angled ridges 208 that protrude from a relative planer face of the base 202. The height of the ridges 208 gradually increases in the direction of the closed end of the clamp (i.e., the direction of the base of the jaw 204).

In operation, the cable 104 is inserted into the jam cleat 200 (as shown) after the loop 105 has been tightened around the objects to be tethered. Once inserted, any upward force imparted on the cable 104, such as would potentially loosen the loop 105, will instead cause the cable 104 to be pushed deeper into the clamp, keeping the loop 105 taught.

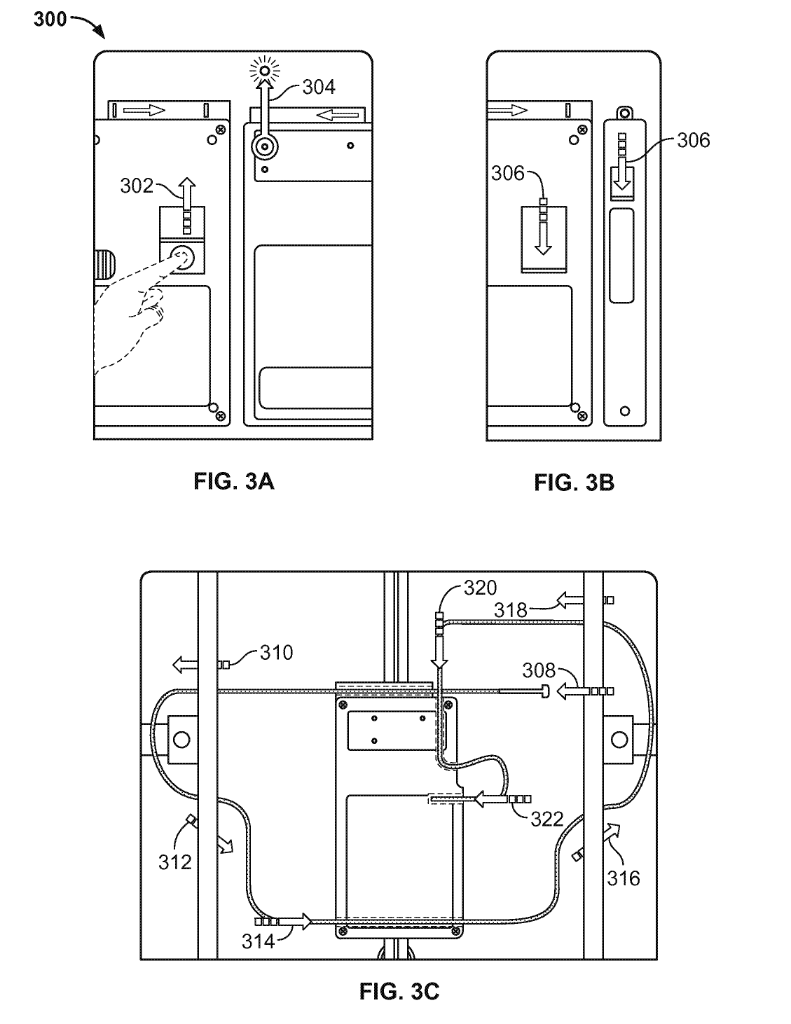

FIGS. 3A-3C illustrate an example method 300 for sealing an apparatus (in this case an entrance barrier) using, for example, the security system 100 described above. Starting at FIG. 3A, at step 302 the ON/OFF switch (164) is accessed by raising the first access panel (170). At step 304 security system (100) is activated by actuating the ON/OFF switch (164). The status indicator light (155a) on the front face (106) of the housing (102) visually confirms that the security system (100) has been activated. In some examples, pressing the ON/OFF switch is optional. For instance, in some cases, the ON/OFF switch may be used when the user wants to turn on the security device and let it obtain its baseline GPS data, or perform wireless communications, prior to being locked into place. In such examples, if the user just wants to lock the security system and go, then (s)he would not use the ON/OFF switch. The security system would turn ON automatically when the second end of the cable is inserted into the secondary cable lock, closing the electrical circuit.

Moving on to FIG. 3B, at step 306 the first and second access panels (170) and (182) are moved downward to the closed position. Referring now to FIG. 3C, at step 308, the cable (104) is threaded, from the second end (120), through the upper cable passage (142), such that the shank at the first end (118) extends into the upper cable passage and the head abuts the side of the housing (102). This causes the first contact (138) to make an electrical connection with the cable (104) near the first end (118), e.g., with the bolt-shaped structure. At steps 310 and 312, the cable (104) is pulled past, and wrapped around, a first object to be tethered. At (optional) step 314, the cable (104) is threaded through the lower cable passage (144). At steps 316 and 318, the cable (104) is pulled past, and wrapped around, a second object to be tethered to the first object. At step 320, the cable (104) is extended through the primary cable lock (128). Finally, at step 322, the second end of the cable (104) is inserted into to the secondary cable lock (130) to form the loop (105). After the cable (104) is extended through the primary cable lock (128), but before or after the second end (120) is inserted into the secondary cable lock (130), the cable is pulled taught to secure the objects to be tethered. With the cable 104 being fully installed, the electrical circuit (136) is closed and the cable carries a detectable current. In response to the current running through the cable (104), the locking device (134) forces a locking pin into the path of the release button (132), inhibiting the cable from being removed from the secondary cable lock (130). The status indicator lights (155b) and (155c) visually confirm that the security system (100) is set.

Once the security system (100) is set, the onboard computing device (152) can monitor system integrity, for example, based on signals received from electrical circuitry within the housing (102). The electrical circuitry is responsive to a breach that disrupts the electrical state of the interior electrical circuit (136) or that of the cable (104). For example, if the cable (104) were severed, the state of the electrical circuit (136) and the cable (104) itself will be significantly affected (i.e., by breaking or altering the conductive path), which can be readily identified by the onboard computing device 152. The onboard computing device (152), however, may also be able to detect more subtle and sophisticated attempts at breaching the security system (100). For example, the onboard computing device (152) can be configured to identify slight changes in the current carried by the cable (104). These slight changes in the measured current can signal that the cable has been spliced or otherwise tampered with. In any event, if it is determined that the security system (100) has been breached, relevant data regarding the breach (e.g., date/time and location data) can be saved in computer memory and/or transmitted to an authorized receiver.

A user may be able to visually confirm that the security system (100) has been breached by observing the state of the status indicator lights (155a-155c). As noted above, the status indicator lights (155a-155c) can display a state of an electrical or mechanical component of the security system (100). For example, the status indicator lights (155a-155c) can indicate that the established conductive path has been separated (e.g., when the cable (104) has been severed) or otherwise altered. In some examples, the onboard computing device (152) is configured to control the status indicator lights (155a-155c) such that they reflect the current state of the corresponding system component. However, the onboard computing device (152) could also be configured to control the status indicator lights (155a-155c) such that they reflect a previous state of the corresponding system component. In this case, a user would be able to visually confirm that the security system (100) had been breached, even if the cable had been previously cut and reattached.

In addition, a user can visually confirm that the security system (100) has been breached by observing the physical state of the housing (102). For example, if the onboard computing device (152) were accessed (e.g., via the access panels 170 and/or 182) or tampered with, visual damage to the housing (102) would be evident.

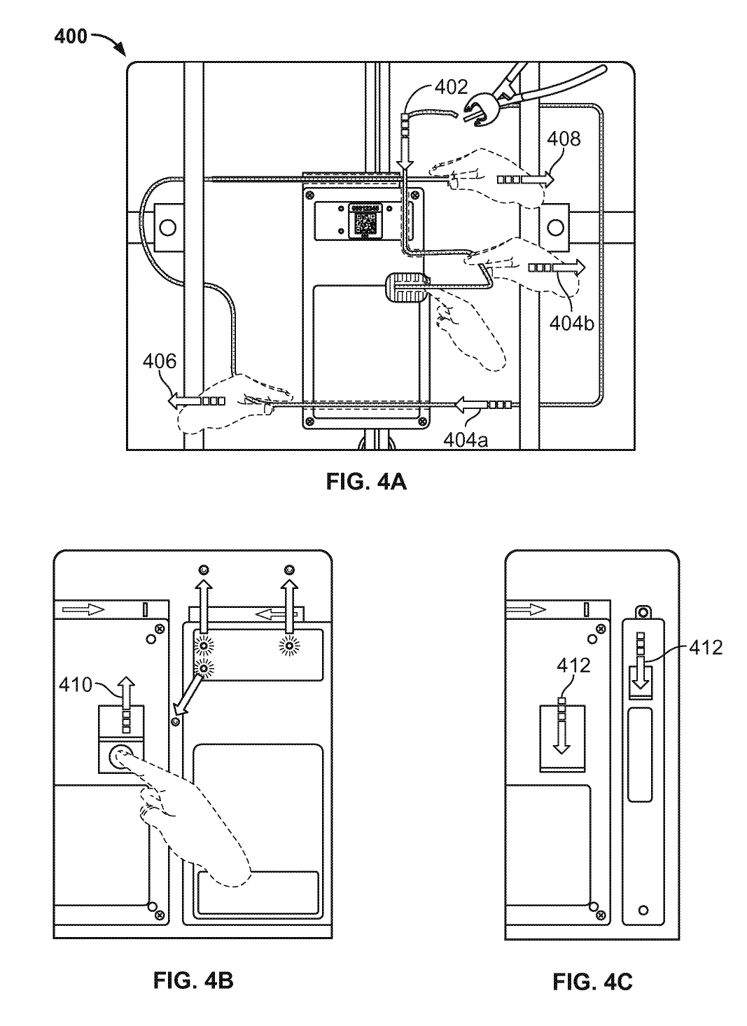

FIGS. 4A-4C illustrate an example method 400 for unsealing an apparatus (in this case an entrance barrier). Starting at FIG. 4A, at step 402 the cable (104) is severed upstream of the primary cable lock (128) to break the loop (105). With the cable (104) being severed, the electrical circuit (136) is opened and the cable non longer carries a current. In response to the loss of current, the locking device (134) removes the locking pin from the path of the release button (132), allowing the release button to move freely. At steps 404a and 404b, the release button (132) is pressed, and the cable (104) is removed from the secondary cable lock (130). At steps 406 and 408, the severed sections are completely removed from the housing (102), and from around the tethered objects. The status indicator lights (155b) and (155c) visually confirm that the security system (100) has been breached. At step 410, the first access panel (170) is raised to access the ON/OFF switch (164). At step 412, the ON/OFF switch is actuated to deactivate the security system (100). The status indicator light (155a) visually confirms that the security system is deactivated. Finally, at step 414, the first and second access panels (170) and (182) are moved to the closed position.

In the current example, where the second end (120) of the cable (104) is cap-less and unaltered, the cable (104) can be re-used after being severed to release it from the housing (102). That is, after the cable (104) is severed and the severed sections are completely removed from the housing (102), the security system (100) can be reused—with the severed end now providing the second end of the cable (104)—to secure the same or different objects. The cable (104) can also be severed to easily adjust its length, without compromising the effectiveness of the security system (100). Thus, the security system (100) can be both readily adjustable to various applications and relatively inexpensive in operation.

The use of terminology such as “front,” “back,” “top,” “bottom,” “over,” “above,” and “below” throughout the specification and claims is for describing the relative positions of various components of the system, and other elements described herein. Similarly, the use of any horizontal or vertical terms to describe elements is for describing relative orientations of the various components of the system, and other elements described herein. Unless otherwise stated explicitly, the use of such terminology does not imply a particular position or orientation of any components relative to the direction of the Earth gravitational force, or the Earth ground surface, or other particular position or orientation that the system, and other elements may be placed in during operation, manufacturing, and transportation. In addition, the positions and orientations of the various passages, openings, switches, ports, display elements in or on the housing as described above are merely exemplary, and can be located at other positions or with other orientations.

A number of embodiments of the invention have been described. Nevertheless, it will be understood that various modifications may be made without departing from the spirit and scope of the inventions. For example, in the foregoing discussion the first and second ends of the flexible cable were described as being configured as electrical contacts for forming a continuous conductive path. In some other examples, however, either of the first and second ends of the flexible cable can be inductive couplers, creating an electrically continuous path that can carry a current through induction. As another example, rather than an electrically conductive cable, the cable could be a fiber optic cable or an acoustic transmission cable, and the housing could incorporate appropriate optical or acoustic sensors to detect tampering of the cable.

What is claimed is:

1. A security system, comprising:
a housing defining an interior cavity;
a flexible cable comprising an electrically conductive body extending from a first end to a second end, at least a portion of the first and second ends of the cable configured to be held within the interior cavity;
a locking assembly disposed in the interior cavity and configured to secure the cable to the housing;
an electrical circuit disposed in the interior cavity, the cable and electrical circuit arranged such that:
a continuous electrical path is formed when the cable is secured to the housing by the locking assembly and at least a portion of each of the first and second ends of the cable are held within the interior cavity, and
the electrical path is altered when:
the cable is detached from the housing;
the cable is tampered with; or
either of the first and second ends of the cable are entirely removed from the interior cavity; and
a monitoring sub-system disposed within the interior cavity and configured to monitor an electrical state of the cable.

2. The system of claim 1, wherein the first end of the cable comprises an elongated shank crowned by an enlarged head.

3. The system of claim 1, wherein the second end of the cable comprises an open end of the cable.

4. The system of claim 1, wherein the electrical circuit comprises a first electrical contact positioned within the interior cavity so as to be in electrical communication with the first end of the cable, when the first end is held fixed within the interior cavity.

5. The system of claim 1, wherein the electrical circuit comprises a second electrical contact positioned within the interior cavity so as to be in electrical communication with the second end of the cable, when the second end is held fixed within the interior cavity.

6. The system of claim 1, wherein the locking assembly comprises:
a primary lock comprising a one-way cable locking mechanism and;
a secondary lock comprising a button-release cable locking mechanism.

7. The system of claim 6, wherein an electrical contact of the electrical circuit is integrated with the secondary lock of the locking assembly, such that the second end of the cable is held against the electrical contact by the secondary lock.

8. The system of claim 6, wherein the secondary lock further comprises a locking device comprising:
a movable pin; and
a driving mechanism responsive to the electrical state of the cable and configured to drive the pin between a first position where the pin impedes movement of a release button of the second secondary lock and a second position where the pin allows the release button to move freely.

9. The system of claim 8, wherein the driving mechanism comprises an electrical step motor.

10. The system of claim 8, wherein the driving mechanism comprises an electromagnetic motor.

11. The system of claim 1, wherein the monitoring sub-system comprises a current sensor designed to detect changes in a current carried by the cable.

12. The system of claim 11, wherein the current sensor comprises a Rogowski coil for sensing current flux.

13. The system of claim 1, further comprising an onboard computing device electronically connected to the monitoring sub-system, wherein the onboard computing device is configured to determine if the security system has been breached based on signals received from the monitoring sub-system.

14. The system of claim 13, wherein the onboard computing device is configured to transmit system integrity information to an authorized receiver.

15. The system of claim 13, wherein the onboard computing device is configured to transmit location information to an authorized receiver.

16. The system of claim 13, wherein the onboard computing device is configured to store system integrity information and/or location information in computer memory.

17. The system of claim 13, further comprising:
an activation switch supported by the housing and electrically connected to the onboard computing device;
a movable first access panel aligned with the activation switch; and
a first panel lock disposed within the housing and arranged so as to impede movement of the first access panel when the first end of the cable is held fixed within the housing.

18. The system of claim 17, wherein the first panel lock comprises:
a block positioned in a passageway of the housing and configured to contact the cable, when the cable is secured to the housing;
a spring-biased post supporting the block; and
a sliding door-stop coupled to the post such that vertical movement of the post causes horizontal movement of the door-stop into a path of the first access panel.

19. The system of claim 13, further comprising:
a data link port supported by the housing and electrically connected to the onboard computing device; and
a movable second access panel aligned with the data link port; and
a second panel lock disposed within the housing and arranged so as to impede movement of the second access panel when the first end of the cable is held fixed within the housing.

20. The system of claim 19, wherein the second panel lock comprises:
a block positioned in a passageway of the housing and configured to positioned in a passageway of the housing and configured to contact the cable, when the cable is secured to the housing; and
a spring-biased door-stop coupled to the block such that vertical movement of the block causes horizontal movement of the door-stop into a path of the second access panel.

21. The system of claim 1, further comprising a jam cleat mounted to the housing, the jam cleat comprising a base and a jaw, the base and the jaw together forming a clamp configured to receive and hold the cable.

22. The system of claim 21, wherein a surface of the base comprises a set of angled ridges.

23. A security system, comprising:
a housing defining an interior cavity;
a flexible cable comprising a body extending from a first end to a second end, at least a portion of the first and second ends of the cable configured to be held within the interior cavity;
a locking assembly disposed in the interior cavity and configured to secure the cable to the housing; and
a monitoring sub-system disposed within the interior cavity and configured to generate a signal in the cable and to detect the signal to monitor a state of the cable; and
wherein the monitoring sub-system and cable are configured such that:
a continuous signal path is formed when the cable is secured to the housing by the locking assembly and at least a portion of each of the first and second ends of the cable are held within the interior cavity, and
the signal path is altered when:
the cable is detached from the housing;
the cable is tampered with; or
either of the first and second ends of the cable are entirely removed from the interior cavity.
